(19) United States
(12) Patent Application Publication
(10) Pub. No.: US 2005/0172549 A1
(43) Pub. Date: Aug. 11, 2005

(54) Mulch shield

(76) Inventor: David M. Allen, Howell, MI (US)

Correspondence Address: HARNESS, DICKEY & PIERCE, P.L.C., P.O. BOX 828, BLOOMFIELD HILLS, MI, 48303, US

(21) Appl. No.: 10/775,896

(22) Filed: Feb. 10, 2004

(51) Int. Cl. A01G 13/02

(52) U.S. Cl. 47/32.4

(57) ABSTRACT

A mulch shield for surrounding a trunk or stem of a plant that may include a body having a bendable wall member, and a lower flange that is coupled to the body and which extends therefrom in a radially outward direction. A slit may be formed through both the wall member and the lower flange that permits the body to be positioned in a first, generally C-shaped condition that is adapted to permit the mulch shield to be placed about the trunk or stem of the plant, and a second condition in which the wall member encircles the trunk or stem of the plant. A closure may be employed to maintain the body in the second condition.

### INTRODUCTION

The present invention generally relates a landscape barrier for protecting the trunk or stem of a plant and more particularly to a mulch shield that permits mulching to be maintained in a spaced condition from the trunk or stem of the plant to promote air circulation in an area proximate the trunk or stem of the plant as well as inhibit the occurrence of disease or rot within the trunk or stem.

Damage to tree trunk bark is often caused by landscaping tools, such as weed trimmers. To protect tree trunk bark from damage, landscapers often apply a layer of mulch around the trunk. Often times, the mulch is applied too thickly and/or in contact the bark of the trunk, resulting in moisture buildup in ways that may promote disease or damage, e.g., rot, to the roots or bark of the tree. Traditional bark protectors are porous and as such, do not retard or inhibit rot in situations where wet mulch is piled against the bark of a tree. Accordingly, there remains a need in the art for an improved tree trunk protector.

### SUMMARY

In one form, the present teachings provide a mulch shield for surrounding a trunk or stem of a plant. The mulch shield may include a body having a bendable wall member, a lower flange that is coupled to the body and which extends therefrom in a radially outward direction. A slit is formed through the wall member and the lower flange that permits the body to be positioned in a first, generally C-shaped condition that is adapted to permit the mulch shield to be placed about the trunk or stem of the plant, and a second condition in which the wall member encircles the trunk or stem of the plant. A closure means may be employed to maintain the body in the second condition.

In another form, the present teachings provide a method for protecting a tree trunk that includes: providing a mulch shield having a body and a lower flange, the body having a bendable wall member, the lower flange being coupled to the body and extending therefrom in a radially outward direction; opening the mulch shield such that the body is generally C-shaped; fitting the body about the tree trunk; and closing the body so as to form a circumferentially extending collar about the tree trunk.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a mulch shield constructed in accordance with the teachings of the present invention;

FIG. 2 is a perspective view of the mulch shield of FIG. 1 in an installed condition;

FIG. 3 is a perspective view similar to that of FIG. 2 but illustrating the slit in an open condition;

FIG. 4 is a partial sectional view of another mulch shield similar to that of FIG. 1 taken generally perpendicular to a longitudinal axis of the mulch shield and illustrating a living hinge in greater detail;

FIG. 5 is a front elevation view of the mulch shield of FIG. 1;

FIG. 6 is a partial sectional view of yet another mulch shield similar to that of FIG. 1 taken generally perpendicular to a longitudinal axis of the mulch shield and illustrating an integral hook fastener in greater detail;

FIG. 7 is a partial view of yet another mulch shield constructed in accordance with the teachings of the present invention illustrating the bodies in a retracted condition;

FIG. 8 is a view similar to that of FIG. 7 but illustrating the bodies in an extended condition;

FIG. 9 is a perspective view of the mulch shield of FIG. 7 as installed about a tree and with the bodies in an extended position; and

FIG. 10 is a perspective view of the mulch shield of FIG. 1 as installed about a tree and with a mulch applied over the area proximate the mulch shield.

### DETAILED DESCRIPTION OF THE VARIOUS EMBODIMENTS

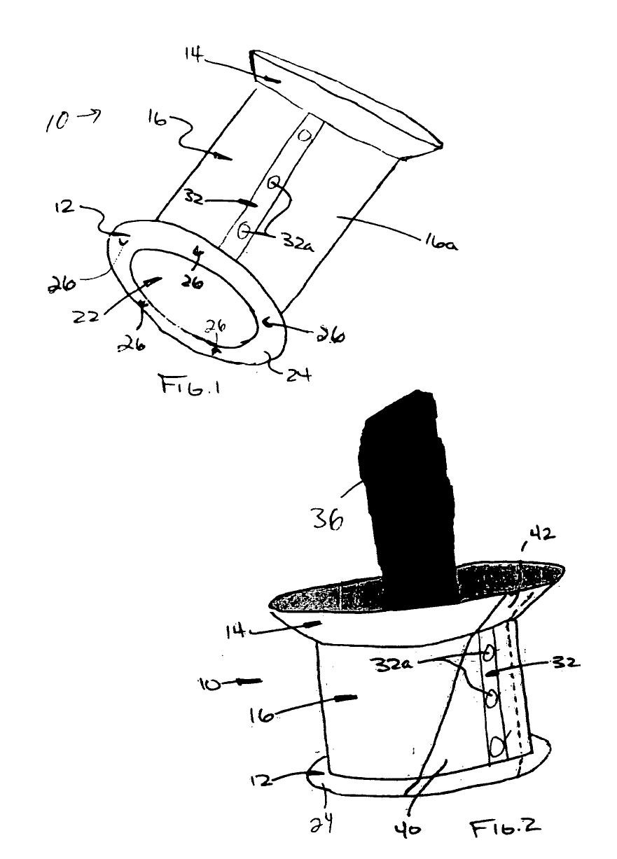

With reference to FIG. 1 of the drawings, a mulch shield constructed in accordance with the teachings of the present invention is generally indicated by reference numeral 10. While the mulch shield 10 is generally described and illustrated as surrounding and therefore protecting the trunk of a tree trunk, those of ordinary skill in the art will appreciate in view of this disclosure that the mulch shield 10 may be used to protect portions (e.g., the stem) of a variety of different plants.

The mulch shield 10 may generally include a base portion 12, an upper flange 14, and a body 16 and may be formed of any desired material, such as a material that may be substantially non-porous. The body 16 may include a wall member 16a that may extend between the base portion 12 and the upper flange 14 and which may be of a height that corresponds to a desired mulch depth. In the example provided, the height of the wall member 16a may be between about 3 inches to about 5 inches and preferably about 4 inches. The mulch shield 10 may be configured so as to define a cavity 22 that may receive the item (e.g., tree trunk) that is to be protected. While the mulch shield 10 is illustrated as defining a generally cylindrical cavity 22, those of ordinary skill in the art will appreciate that the interior and/or exterior of the mulch shield 10 may be of any desired shape, such as square, rectangular, oval, an irregular shape, etc.

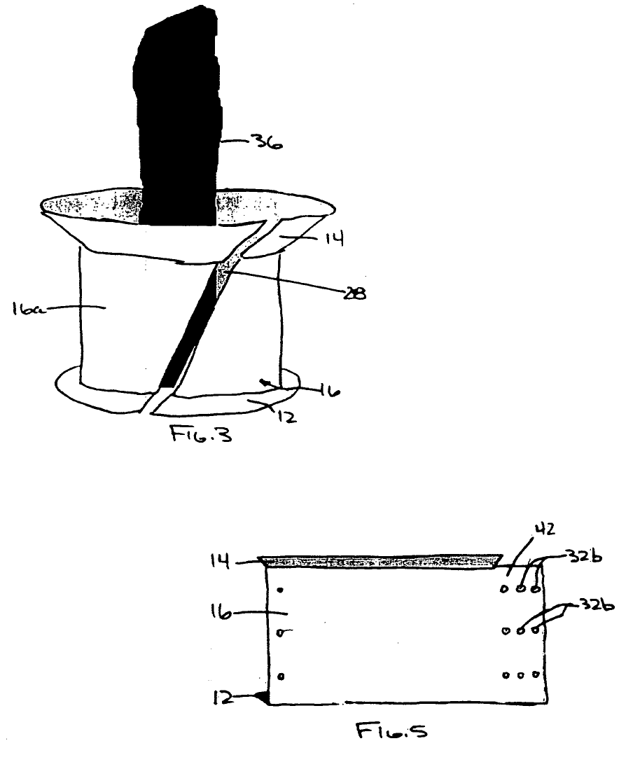

With additional reference to FIG. 2, the base portion 12 may support the mulch shield 10 in a generally upright position relative to the ground. The base 12 may include a lower flange 24 that may extend outwardly from the body 16 in a direction that may be generally perpendicular to the body 16. The lower flange 24 may be any width, such as about 2 inches, to adequately support the mulch shield 10. The lower flange 24 may include a plurality of protrusions or cleats 26, which may be formed on a lower surface of the lower flange 24, that are configured to engage the ground so as to resist movement of the mulch shield 10 relative to the item that is to be protected while a mulch material is being applied to the ground in an area proximate the mulch shield 10.

The upper flange 14 may be coupled to an upper end of the body 16 and extend outwardly therefrom so as to form a guard that aids in preventing materials, such as mulch, leaves and/or litter, from entering the cavity 22. The upper flange 14 may be employed as a sight gauge that permits a technician who may be installing the mulch to gauge the relative depth of the mulch proximate the mulch shield 10. The upper flange 14 may also extend upwardly from the body 16 (i.e., away from the lower flange 12) as it extends outwardly.

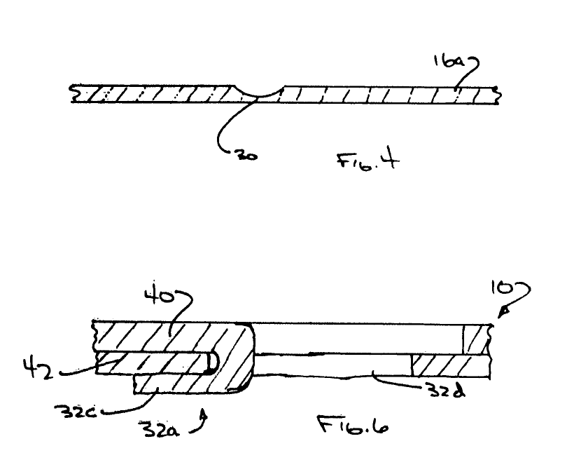

With reference to FIGS. 3 and 4, a slit 28 may be formed in the mulch shield 10 which may extend through the lower and upper flanges 12 and 14 and the body 16. The slit 28 may be formed in any desired manner. For example, the slit 28 may be formed wholly or partially about an axis that is generally parallel to a longitudinal axis of the mulch shield 10, or may be wholly or partially spiral about the longitudinal axis of the mulch shield. The slit 28 permits the body 16 of the mulch shield 10 to be positioned in a first, generally C-shaped condition, which permits a technician to install the mulch shield 10 about the trunk 36 of a tree (or the stem of a plant), and a second condition in which the wall member 16a of the body 16 encircles the trunk 36 of the tree (or the stem of the plant). To further facilitate movement of the mulch shield 10 between the first and second conditions, the mulch shield 10 may be formed with one or more integral living hinges 30 that may be formed on the lower and upper flanges 12 and 14 and the body 16 in a direction that is generally parallel to the longitudinal axis of the cavity 22.

Returning to FIGS. 1 and 2, a closure means 32 may be employed to maintain the body 16 in the second condition. The closure means 32 may be a resilient characteristic of an element, such as the material that forms one or more of the lower flange 12, the upper flange 14 and the body 16, or a band, clamp or spring (not shown) that is coupled to or that forms, in part or in whole, one or more of the lower flange 12, the upper flange 14 and the body 16. In the particular example provided, the mulch shield 10 is formed from a sheet-like material that may be coiled on a roll. The sheet-like material may be configured such that the lower flange 12, the upper flange 14 and the body 16 are pre-formed, or the sheet-like material may be passed through a forming die to form the lower flange 12 and the upper flange 14 in a manner that is similar to the way seamless gutters are formed from a coiled roll of flat metal (aluminum) material. A technician may cut an appropriately sized length of the material from the roll (to thereby form the mulch shield 10) and position the mulch shield 10 about a tree or other plant to be protected. The resilient characteristic of the material from which the mulch shield 10 is formed may generate a tendency in the material that causes it to coil around itself and thereby self-close so that the ends of the wall member 16a abut one another or so that portions (40, 42) of the mulch shield 10 overlap one another. Optionally, one or both of the lower flange 12 and the upper flange 14 may be trimmed as shown in FIG. 5 so as to not extend over all or a portion of one of the overlapping portions (e.g. overlapping portion 42).

With renewed reference to FIGS. 1, 2 and 5, the material that forms the mulch shield 10 may not have a sufficient self-closing characteristic or tendency so that in some situations the closure means 32 may employ one or more fasteners 32a to close the body 16. The fasteners 32a may be any type of fastener, such as rivets, screws, spikes, adhesive tape, clips, Christmas-tree retainers, push-type retainers, and hook-and-loop fasteners (VELCRO®). Apertures 32b may be formed into desired portions of the mulch shield 10, and may be spaced across one or both of the overlapping portions (40, 42) so as to provide the technician with another way in which the size of the cavity 22 may be adjusted to a particular application. In some situations, it may be desirable that the fasteners 32a be configured to fail or cause the material into which they are secured to fail (e.g., through sizing of the apertures 32b into which the fastener 32a extends) to thereby release the fastener 32a so that the closure means 32 will permit the mulch shield 10 to be moved toward the first position in response to growth of the tree or plant, the formation of ice within the cavity 22, etc.

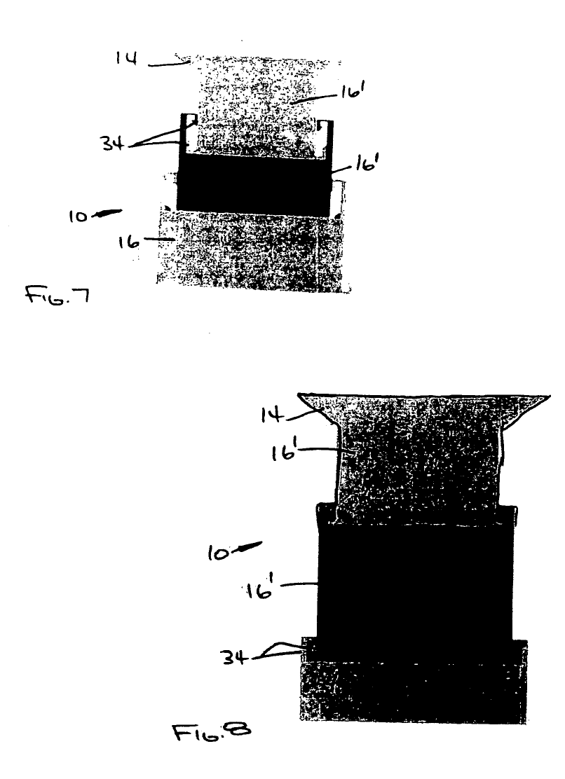

Additionally or alternatively, the fasteners 32a may include tabs 32c and apertures 32d that are formed into one or more portions of the mulch shield 10 as is shown in FIG. 6. For example, one or more hook-shaped tabs 32c may be punched into one of the overlapping portions (e.g., overlapping portion 40), while apertures 32d may be formed into the other one of the overlapping portions (e.g., overlapping portion 42. Engagement of the tabs 3c to the other one of the overlapping portions tends to maintain the mulch shield 10 in the second condition.

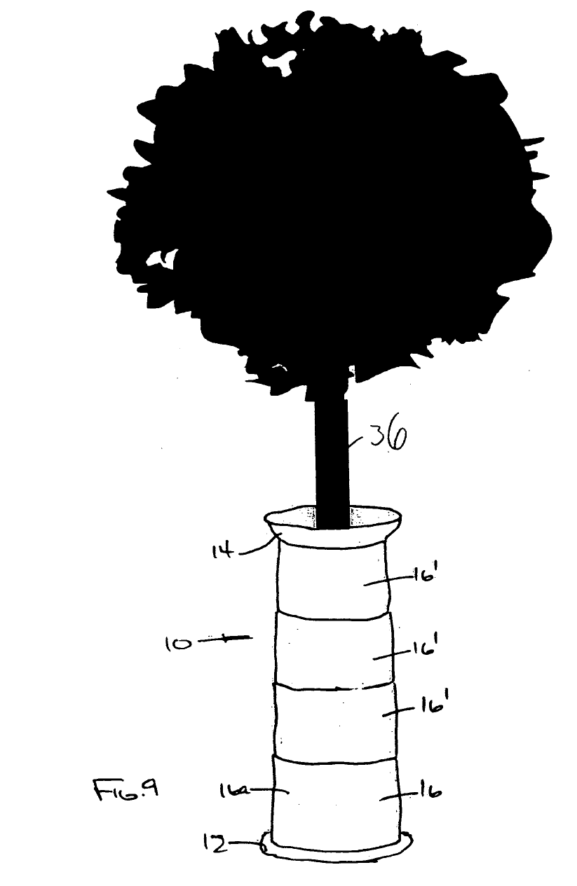

With reference to FIGS. 7 through 9, the mulch shield 10 may include multiple, telescoping bodies 16′. The number of the telescoping bodies 16′ may be varied according to a particular application, and as such, the particular embodiment illustrated is not intended to be limiting in any manner. The mulch shield 10 may include one or more telescoping bodies 16′ that may be telescopically received into and extended from the body 16 so as to extends the overall height of the mulch shield 10 to a suitable height to thereby protect a larger portion of the tree trunk 36 or plant, as when applying a mulch, to prevent damage to portions of the tree or plant due to insect, animals, cold weather or salt. The upper flange 14 may be formed on an upper-most one of the bodies 16′.

As one of ordinary skill in the art will appreciate from the drawings, each bodies 16′ is substantially similar to one another but differs in its diameter so as to be received into and/or receive an adjacent one of the body 16 or bodies 16′. To maintain one or more of the bodies 16′ in the extended position, the body 16 and bodies 16′ may employ a retention device, such as a taper fit, which permits the body 16 and the bodies 16′ to frictionally fit an adjacent one of the bodies 16′ when the adjacent one of the bodies 16′ is positioned in an extended position. Additionally or alternatively, the retention device may include one or more locking tabs 34 that may engage an adjacent one of the body 16 or a body 16′ when the body 16′ has been positioned in the extended position. The locking tabs 34 may be interlocking clips that formed on each adjacent pair of the bodies, or may extending inwardly into an L-shaped or inverted T-shaped groove that is formed in a radially inward one of the bodies 16′. In this latter embodiment, location of the tab in a longitudinally extending portion of the groove permits the body 16′ to be moved between the retracted and extended positions, while rotation of the tab within the circumferentially-extending lower portion of the groove effectively locks the body 16′ in the extended position.

In operation, the mulch shield 10 may be positioned in the first condition, placed around a desired tree trunk 36 such that the tree trunk 36 is disposed in the cavity 22. Thereafter, the mulch shield 10 may be positioned in the second condition and in contact with the ground as is shown in FIG. 2. For smaller plants, the mulch shield 10 may simply be placed over the top of the plant and moved into contact with the ground. The mulch shield 10 may be positioned and sized such that a desired space, such as about two inches, is present between the inside surface of the mulch shield 10 and the outer surface of the tree trunk 36. If desired, fasteners 32a may be employed to secure overlapping portions of the mulch shield 10 to one another. A mulch 38 (FIG. 10) may be applied to the ground in an area proximate the mulch shield 10 to a desired level, such as at a point that corresponds to a lowest point of the upper flange 14 (e.g., where the upper flange 14 and the body 16 intersect one another).

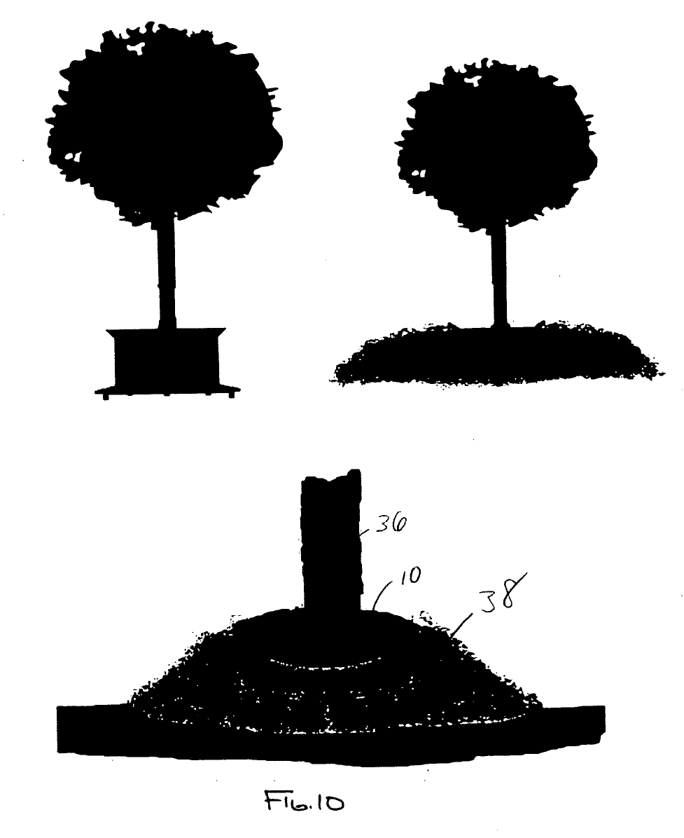

If the mulch shield 10 is equipped with multiple, telescoping bodies 16′, the multiple, telescoping bodies 16 may be moved from the retracted position (FIG. 7) to the extended position (FIGS. 8 and 9) prior to the application of the mulch to the ground. After mulch has been applied to a desired level, such as to the top of the body 16, the multiple, telescoping bodies 16′ may be placed into the retracted position relative to the body 16.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

1. A mulch shield for surrounding a trunk or stem of a plant, the mulch shield comprising:
a body having a bendable wall member;
a lower flange coupled to the body and extending therefrom in a radially outward direction; and
closure means;
wherein a slit is formed through the wall member and the lower flange that permits the body to be positioned in a first, generally C-shaped condition that is adapted to permit the mulch shield to be placed about the trunk or stem of the plant, and a second condition in which the wall member encircles the trunk or stem of the plant; and
wherein the closure means is operable for maintaining the body in the second condition.

2. The mulch shield of claim 1, wherein the closure means includes a resilient characteristic of at least one of the body and the lower flange.

3. The mulch shield of claim 1, wherein the closure means includes at least one fastener that is employed to secure overlapping portions of the mulch shield to one another.

4. The mulch shield of claim 3, wherein the fastener may be at least one of a rivet, a screw, a spike, an adhesive tape, a clip, a Christmas-tree retainer, a push-type retainer, and a hook-and-loop fastener.

5. The mulch shield of claim 3, wherein a plurality of holes are preformed in at least one of the body and the lower flange for receiving the at least one fastener.

6. The mulch shield of claim 3, wherein the fastener includes an aperture and a tab, wherein the aperture is formed into one of the overlapping portions and the tab is coupled to another one of the overlapping portions, the tab being configured to extend through the aperture to secure the overlapping portions to one another.

7. The mulch shield of claim 1, wherein a plurality of cleats are formed on a lower surface of the lower flange.

8. The mulch shield of claim 1, further comprising an upper flange coupled to the body and extending therefrom in a radially outward direction, the slit also extending through the upper flange.

9. The mulch shield of claim 8, wherein the upper flange also extends from the body in an upward direction.

10. The mulch shield of claim 8, wherein the upper flange is spaced apart from the lower flange by a predetermined distance that is associated with a desired mulch thickness.

11. The mulch shield of claim 10, wherein the desired mulch thickness is about 3 inches to about 5 inches.

12. The mulch shield of claim 1, further comprising at least one second body that is configured to be received into the body and telescopically moved with respect to the body between an extended position and a retracted position.

13. The mulch shield of claim 12, wherein an upper-most one of the second bodies includes an upper flange that is coupled to the upper-most one of the second bodies and extends therefrom in a radially outward direction.

14. The mulch shield of claim 13, wherein the upper flange also extends from the upper-most one of the second bodies in an upward direction.

15. The mulch shield of claim 12, further comprising retaining means for retaining each of the second bodies in the extended position.

16. The mulch shield of claim 1, wherein the wall member is formed from a non-porous material.

17. The mulch shield of claim 1, wherein a living hinge is formed in the wall member, the living hinge extending in a direction that is generally parallel to a longitudinal axis of the body.

18. The mulch shield of claim 1, wherein at least a portion of the slit is generally parallel to a longitudinal axis of the body.

19. The mulch shield of claim 1, wherein at least a portion of the slit is spirally shaped.

20. A method for protecting a tree trunk comprising:
providing a mulch shield having a body and a lower flange, the body having a bendable wall member, the lower flange being coupled to the body and extending therefrom in a radially outward direction;
opening the mulch shield such that the body is generally C-shaped;
fitting the body about the tree trunk; and
closing the body so as to form a circumferentially extending collar about the tree trunk.

21. A mulch shield for surrounding a trunk or stem of a plant, the mulch shield comprising:
a body having a bendable wall member that is formed of a non-porous material;
a lower flange coupled to the body and extending therefrom in a radially outward direction;
a plurality of cleats that extend from a lower surface of the lower flange;
an upper flange coupled to the body and extending therefrom in a radially outward and upward direction; and
closure means;
wherein a slit is formed through the wall member, the lower flange and the upper flange that permits the body to be positioned in a first, generally C-shaped condition that is adapted to permit the mulch shield to be placed about the trunk or stem of the plant, and a second condition in which the wall member encircles the trunk or stem of the plant; and
wherein the closure means is operable for maintaining the body in the second condition.
